(19) United States
(12) Patent Application Publication
(10) Pub. No.: US 2007/0230779 A1
(43) Pub. Date: Oct. 4, 2007

(54) DIGITAL CAMERA

(76) Inventor: Hidehiko Sato, Machida-shi (JP)

Correspondence Address: Pamela R. Crocker;Patent Legal Staff, Eastman Kodak Company, 343 State Street, Rochester, NY, 14650-2201, US

(21) Appl. No.: 11/534,799

(22) Filed: Sep. 25, 2006

(30) Foreign Application Priority Data
Mar. 31, 2006 (JP) 2006-099421

(51) Int. Cl. G06K 9/00

(52) U.S. Cl. 382/167

(57) ABSTRACT

A time to process an image signal used as a single frame image of a moving image. When an image signal used as a single frame image of a moving image is processed, a pixel value accumulated in a CCD element is read while being vertically and horizontally added with pixels (S30). The thus-read image signal is temporarily stored in internal memory after having undergone RGB color interpolation processing, resizing, YCC conversion processing, and the like, in a first image processing circuit that is a hardware circuit (S32, S34). A second image processing chip reads the image signal stored in the internal memory and expands the signal into a memory space. The image signal is subjected to comparatively-complicate image processing, including imperfect pixel correction processing, in the manner of software (S36). Since hardware processing and software processing are separated from each other, the number of memory expansion processing operations can be minimized, thereby shortening a processing time.

### CROSS REFERENCE TO RELATED APPLICATIONS

This application claims priority to Japanese Patent Application No. 2006-099421 filed on Mar. 31, 2006, which is incorporated herein by reference in its entirety.

### FIELD OF THE INVENTION

The present invention relates to a digital camera, and more particularly, to flow of processing of an image signal.

### BACKGROUND OF THE INVENTION

A digital camera which handles an image as electronic data has become pervasive. Some digital cameras can capture and record a moving image as well as a still image. When an image signal for a moving image is handled, signal processing procedures, which differ from conventional signal processing procedures for a still image, are sought. Namely, in the case of a still image, strong desire exists for high image quality. In contrast, in the case of a moving image, primary importance is placed on maintenance of a predetermined frame rate (e.g., 1/30 sec.), and a strong demand exists for shortening of a time to process an image signal.

When the same processing procedures are used to process the image signal for a moving image and the image signal for a still image, which differ from each other in terms of priorities, a problem arises in at least one of them. For instance, in the case of a still image, pixel values accumulated in a CCD element are read without addition of pixels, and the pixel values are subsequently subjected to various image processing operations by means of software. When the processing procedures are applied without modifications to the image signal for a moving image, reading pixel values or image processing executed by software involves consumption of time, which poses a problem of a failure to maintain the frame rate.

In order to shorten the time to process an image signal, a technique of reading a pixel value while adding pixels to the pixel value has hitherto been known (e.g., Japanese Patent Laid-Open Publication No. 2002-185854 and the like). As a result of addition of a pixel, the number of pixels to be finally read is diminished, and a time required to process a read pixel value can be shortened. However, it has been difficult to sufficiently shorten a processing time by means of merely reading a pixel value while adding pixels to the pixel value.

### SUMMARY OF THE INVENTION

Accordingly, the present invention provides a digital camera capable of shortening a time to process an image signal for a moving image.

The present invention provides a digital camera capable of handling at least a moving image and a still image, comprising:

an image-capturing element for capturing an image of a subject;

a pixel value reading unit for reading a pixel value of a unit pixel which is a unit of photoelectric conversion of the image-capturing element, and outputting the pixel value as an image signal;

a first image processing unit for subjecting the image signal to image processing of one or more types by means of a hardware circuit; and

a second image processing unit for subjecting the image signal to image processing of one or more types by means of software processing, wherein,

at least when the image signal used as one frame of a moving image is subjected to processing, image processing to be performed by the second image processing unit is carried out after completion of all image processing operations performed by the first image processing unit.

In a preferred mode, at least when the image signal used as one frame of a moving image is subjected to processing,

the pixel value reading unit reads a pixel value while horizontally, vertically adding up pixels;

the first image processing unit subjects the image signal output from the pixel value reading unit to image processing including at least one of RGB color interpolation processing, resizing processing, and YCC image preparation processing; and

the second image processing unit subjects the image signal output from the first image processing unit to image processing including at least processing for correcting an imperfect pixel attributable to imperfections in the unit pixel. In this case, the digital camera further comprises a storage unit for storing imperfection information including positional information achieved before the imperfect pixel, which is an imperfect unit pixel, is subjected to pixel addition processing; and, at least when an image signal used as one frame of a moving image is subjected to processing, the second image processing unit preferably calculates, on the basis of the imperfection information, the position of the imperfect pixel that has undergone pixel addition and image processing performed by the first image processing unit, thereby performing imperfect pixel correction processing. Further, the imperfection information further includes imperfection intensity information about the imperfect pixel that has not yet undergone pixel addition processing; and, at least when an image signal used as one frame of a moving image is subjected to processing, the second image processing unit preferably identifies an imperfect pixel whose imperfection intensity is less than a predetermined threshold value, on the basis of imperfection information, and preferably omits imperfect pixel correction processing for an imperfect pixel whose imperfection intensity is less than the predetermined threshold value.

In another preferred mode, when an image signal used as a still image is subjected to processing, the pixel value reading unit outputs an image signal to the second image processing unit after having read a pixel value without addition of a pixel value; and the second image processing unit subjects the image signal output from the pixel value reading unit to image processing including imperfect pixel correction processing. In this case, the second image processing unit first performs imperfect pixel correction processing and then performs other image processing operations.

In yet another preferred mode, the digital camera further comprises a compensation unit for subjecting the image signal, which has undergone vertical addition of pixels, to imperfect pixel correction processing by means of a hardware circuit; and, when an image signal used as a preview image is subjected to processing, the pixel value reading unit reads a pixel value while adding pixel values to the pixel value in only a vertical direction, and outputs an image signal to a correction unit; the correction unit subjects the image signal output from the pixel value reading unit to imperfect pixel correction processing; the first image processing unit subjects the image signal output from the correction unit to image processing including at least one of RGB color interpolation processing, resizing processing, and YCC image preparation processing; and the second image processing unit subjects an image signal output from the first image processing unit to image processing other than imperfect pixel correction processing.

According to the present invention, when an image signal used as one frame of a moving image is processed, the image signal is first subjected to all image processing operations performed by a first image processing unit; namely, a hardware circuit. Subsequently, the image signal is subjected to image processing performed by a second image processing unit; namely, software processing. Put another way, hardware processing and software processing are totally separated from each other. Accordingly, the number of memory expansion processing operations required during software processing can be minimized, thereby shortening overall processing time.

The invention will be more clearly comprehended by reference to the embodiments provided below. However, the scope of the invention is not limited to those embodiments.

### BRIEF DESCRIPTION OF THE DRAWINGS

Preferred embodiments of the present invention will be described in detail based on the following figures, wherein:

FIG. 1 is a block diagram showing the configuration of a digital camera which is an embodiment of the present invention;

FIG. 2 is a view showing an example configuration of a color filter used for a CCD;

FIG. 3 is a view showing example imperfection information;

FIG. 4 is a flowchart showing the flow of processing of an image signal used as a still image;

FIG. 5 is a flowchart showing flow of processing of an image signal used as a preview image;

FIG. 6 is a flowchart showing the flow of processing of an image signal used as one frame image of a moving image;

FIG. 7 is a view showing example pixel addition;

FIG. 8 is a view showing a change in coordinates of an imperfect pixel induced by addition of pixels;

FIG. 9 is a view showing a change in coordinates of an imperfect pixel induced by resizing;

FIG. 10 is a view showing a change in coordinates of an imperfect pixel induced by interpolation; and

FIG. 11 is a flowchart showing flow of processing of an image signal performed when imperfect pixel correction processing is performed before RGB color interpolation processing and resizing.

### DETAILED DESCRIPTION OF THE PREFERRED EMBODIMENTS

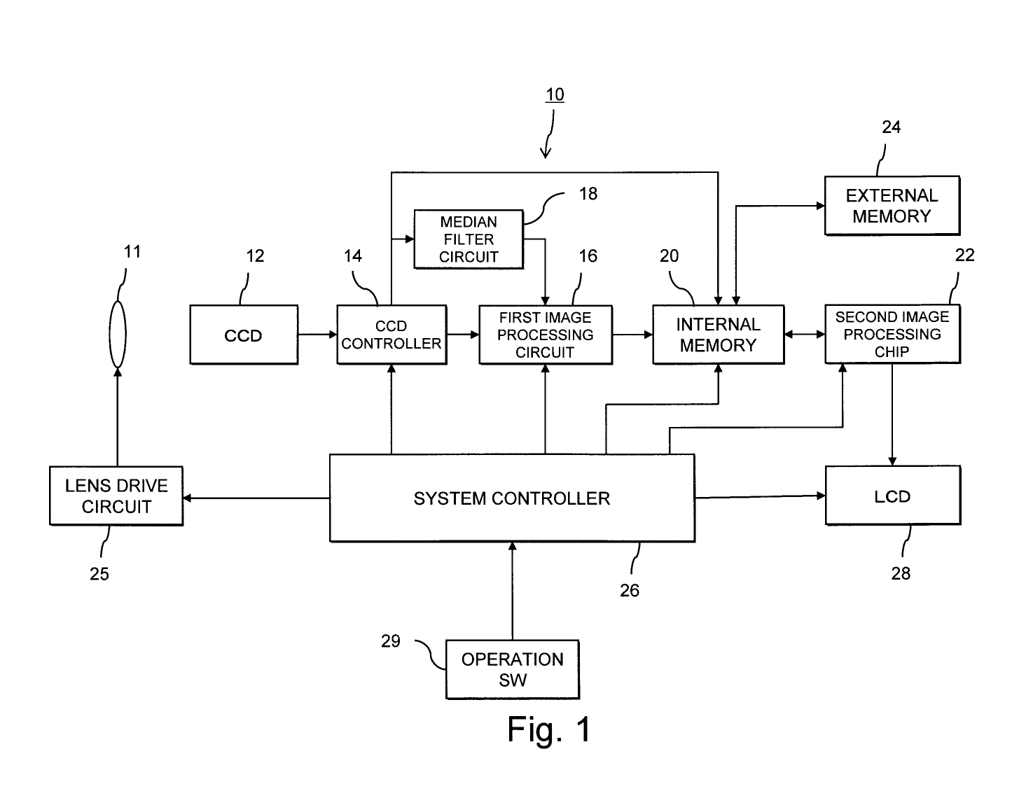

An embodiment of the present invention will be described hereinbelow by reference to the drawings. FIG. 1 is a block diagram showing the configuration of a digital camera 10 which is an embodiment of the present invention. A lens unit 11 has a zoom lens unit, and is arranged so as to be able to change a photographic angle of view, as required. As in the case of an ordinary lens unit, the lens unit 11 is provided with a shutter assembly, an aperture, and the like.

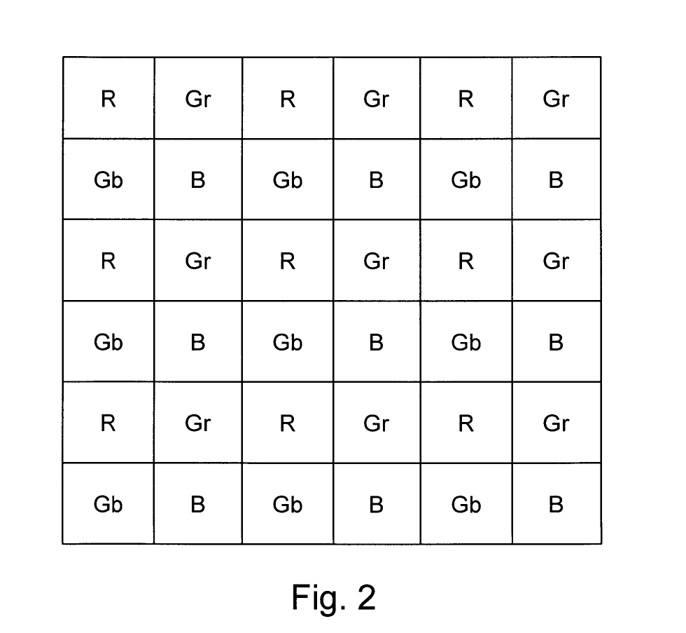

Light gathered by the lens unit 11 forms an image on a CCD 12. The CCD 12 is formed form a plurality of CCD elements, and each of the CCD elements subjects the gathered light to photoelectric conversion and accumulates the thus-converted light as an electric charge signal. Each of the CCD elements corresponds to a unit pixel which is a unit of photoelectric conversion, and the electric charge signal accumulated in each of the CCD elements corresponds to a unit pixel value. The present embodiment employs a color filter of Bayer arrangement such as that shown in FIG. 2. In the Bayer arrangement, green colors (Gr, Gb) requiring a high resolution are arranged in a checkered pattern. Two types of colors requiring comparatively-low resolution; namely, red and blue colors (R, B), are arranged in the remaining areas. As a matter of course, the color filter shown in FIG. 2 is an example, and another color filter may also be used.

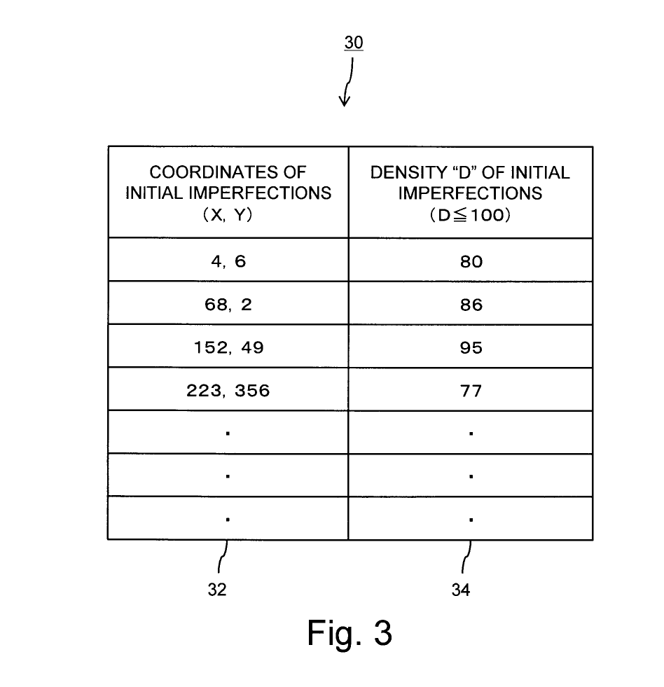

Naturally, all of a plurality of CCD elements (pixels) constituting the CCD 12 preferably operate normally. However, in reality, totally eliminating imperfect pixels (imperfect CCD elements) is difficult. One CCD 12 includes several imperfect pixels. The imperfect pixels become a cause of deterioration of an image. Imperfect pixels are usually subjected to correction processing. In the present embodiment, in order to appropriately perform imperfect pixel correction processing, the position (coordinates) of an imperfect pixel included in the CCD 12 and the strength of the same are measured in advance. These pieces of information are stored in internal memory 20 as imperfection information. FIG. 3 is a view showing an example of imperfect pixel information 30. Coordinates 32 of an imperfect pixel included in one CCD 12 and strength 34 of the pixel are stored in a mutually-associated manner in the imperfect pixel information 30. As will be described in detail later, coordinates and strength of an imperfect pixel are changed when the pixel is subjected to processing such as pixel addition and the like. In order to distinguish coordinates and intensity of an imperfect pixel achieved before processing from coordinates and intensity of an imperfect pixel achieved after processing, an imperfect pixel having not yet undergone processing such as pixel addition and the like is hereinafter called an “initial imperfect pixel.” Coordinates of the initial imperfect element are hereinafter called “initial imperfect element coordinates (X,Y),” and imperfection intensity of the initial imperfect element is hereinafter called “initial imperfect strength D.”

A CCD controller 14 reads a pixel value (an electric charge signal) accumulated in each of the CCD elements at predetermined timing, and outputs the thus-read pixel value as an image signal. The CCD controller 14 changes a reading mode according to an application of a read image signal. Specific reading modes will be described in detail later.

A first image processing circuit 16 subjects the read image signal to comparatively-simple image processing; namely, RGB color interpolation processing, resizing processing, YCC conversion processing, and the like, in the manner of hardware. RGB color interpolation processing is for preparing color images of RGB, or three channels per pixel, from a CCD input signal which is a signal of one channel for one pixel (hereinafter called a “one-pixel-and-one-channel signal”). Resizing processing is for scaling up or down the size of an image signal. YCC conversion processing is for converting an image signal expressed in an RGB color into YCC color expression. A color image signal, which has been obtained by subjecting information about a one-pixel-and-one-channel signal read from the CCD 12 to RGB color interpolation, is expressed in three colors; i.e., R (red), G (green), and B (blue). In the state of RGB color expression, various image processing operations performed by a second image processing chip 22, which will be described later, become complicated. For this reason, the RGB color expression is converted into YCC color expression in advance. In YCC color expression, one color is expressed by luminance (Y) and a color difference (Cr, Cb). Since a specific equation for converting RGB color expression into YCC color expression has been known, its explanation is omitted. Image processing, such as RGB color interpolation, resizing processing, and YCC conversion, can be said to be simpler than handshake correction processing, distortion correction processing, and the like, which will be described later. A processing time can be shortened by means of executing comparatively-simple processing operations in the manner of hardware rather than in the manner of software. Accordingly, in the present embodiment, the first image processing circuit 16, which is a processing circuit of hardware, performs comparatively-simple processing. The image signal having undergone predetermined image processing performed by the first image processing circuit 16 is temporarily stored in internal memory 20.

A median filter circuit 18 is for performing pixel imperfection correction processing in the manner of hardware. As is well known, this median filter circuit 18 is a filter for extracting a median of a signal level in an arbitrary small range (a filter range). A manner of setting a filter range can be conceived in various forms. In the present embodiment, a horizontally-long range is used as a filter range. Therefore, in order to cause the median filter circuit 18 to perform pixel imperfection correction processing, a target image signal must have a sufficient resolution in the horizontal direction thereof.

Imperfection correction processing performed by the median filter circuit 18 is processing of hardware. Hence, processing can be performed at high speed. However, fine control of imperfection correction processing is difficult, and highly-accurate imperfect pixel correction processing is difficult. Consequently, the median filter circuit 18 can be said to be an imperfection correction processing circuit effective solely to an image which has a sufficient horizontal resolution and for which high definition is not required. Since a known conventional technique can be utilized for a specific circuit configuration of the median filter circuit 18, its explanation is omitted.

The second image processing chip 22 is an IC. In accordance with a previously-stored image processing program, the second image processing chip 22 subjects the image signal stored in the internal memory 20 to comparative-complicated image processing in the manner of software. Image processing executed by the second image processing chip 22 includes handshake correction processing, distortion correction processing, face recognition processing, and the like. Further, in the present embodiment, the second image processing chip 22 performs imperfect pixel correction processing, as well. Since imperfect pixel correction processing is of software type, the second image processing chip 22 enables fine adjustment. Imperfect pixel processing can be performed more accurately as compared with hardware processing such as that performed by the previously-described median filter circuit 18. Moreover, an image having insufficient horizontal resolution can be subjected to imperfect pixel correction processing without involvement of a problem.

An LCD 28 displays an image and a menu screen. Upon glance of a preview image appearing on the LCD 28, the user ascertains an angle of an image to be photographed, and the like. In this case, the LCD 28 acts as an electronic finder. Further, a photographed still image or moving image is also displayed on the LCD 28. In that case, the LCD 28 acts as a playback monitor. Further, an operation menu, current settings, and the like, are also displayed. Consequently, the LCD 28 acts also as a user interface.

The external memory 24 is portable memory removably attachable to the digital camera 10, such as an SD memory card, a flash memory card, and the like. A still image and a moving image, which are captured through photographic operations, are stored and preserved in the external memory 24.

A system controller 26 is control means for controlling the entire digital camera 10 in accordance with a user command input via an operation switch 29. Specifically, the system controller 26 controls operations of the CCD controller 14, the first image processing circuit 16, and the second image processing chip 22, which have been previously described, and the like. The system controller 26 outputs a command to a lens drive circuit 25 which drives a zoom lens, as required, thereby controlling a photographic angle of view and focus.

Flow of processing of the image signal performed in the digital camera 10 will now be described. Flow of processing of an image signal varies according to the application of the image signal; namely, a still image, a moving image, and a preview image. Therefore, flow of processing of an image signal will be described for each application hereinbelow.

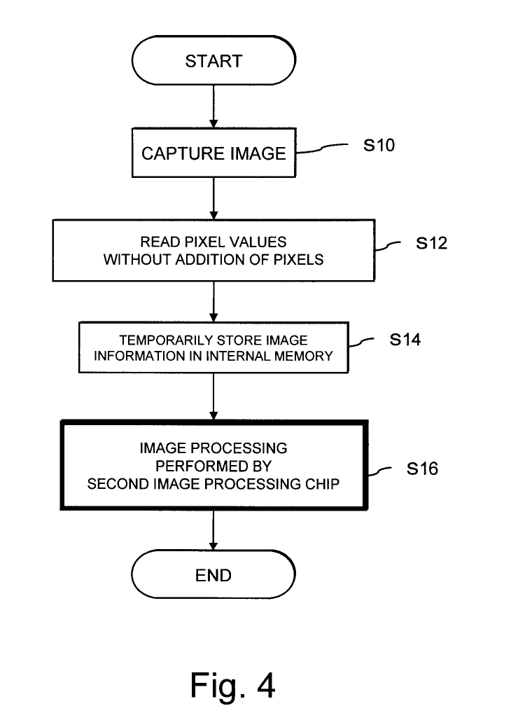

First, the flow of processing performed when an image signal is taken as a still image will be described by reference to FIG. 4. In the flowchart illustrated blow, a block drawn by a fine, solid line depicts hardware processing, and a block drawn by a thick line

When the image signal is used as a still image, the CCD controller 14 reads the pixel value (electric charge information) accumulated in each of the CCD elements through photography operation (S10, S12). An image signal obtained as a result of reading operation is temporarily stored in the internal memory 20 (S14).

In accordance with a predetermined image processing program, the second image processing chip 22 ensures a work memory space; then reads the image signal temporarily stored in the internal memory 20; and expands the image signal in the memory space. During still image processing, all image processing operations are performed in the manner of software in order to perform highly-precise processing (S16). Specifically, imperfect pixel correction processing is performed in the manner of software. Subsequently, RGB color interpolation, resizing processing, and YCC image conversion processing are also performed in the manner of software (S16). Imperfect pixel correction processing is processing for correcting an imperfect pixel included in an image signal. As mentioned previously, the position and strength of the initial imperfect pixel are measured in advance at shipment and stored as imperfection information in internal memory. In accordance with an image processing program, the second image processing chip 22 identifies the position and strength of an imperfect pixel by reference to the imperfection information, and performs correction processing. When another image processing operation is performed without correcting the imperfect pixel, the influence of the imperfect pixel is exerted on surrounding pixels, which sometimes deteriorates image quality of the entire image. In the case of a still image requiring high image quality, imperfect pixel correction processing is performed prior to the other image processing operation.

Upon completion of YCC image conversion processing, the second image processing chip 22 performs another image processing operation, handshake correction processing, distortion correction processing, and the like, without opening the memory space. After completion of all image processing operations, the image signal is converted into a JPEG format and recorded in the external memory 24 as still image data. Concurrently, when the memory space ensured for work is opened, processing is completed.

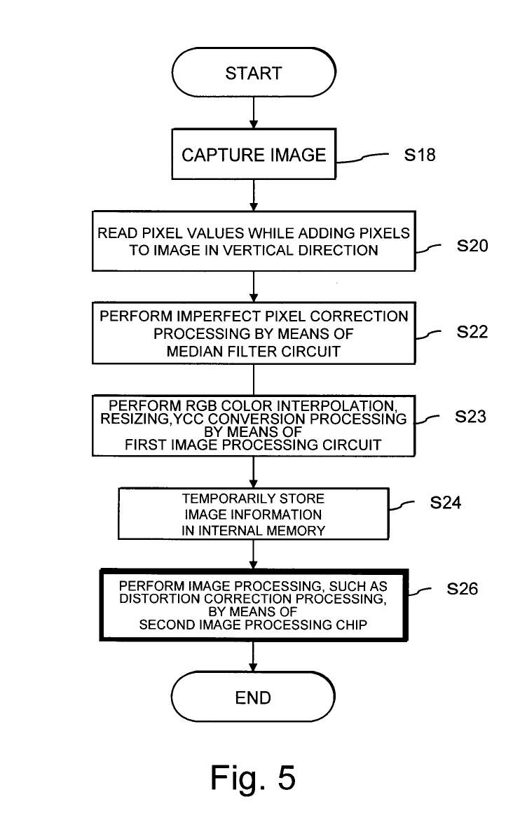

Next, flow of processing performed when an image signal is used as a preview image will be described by reference to FIG. 5. A preview image is required to be processed within a shorter period of time than is a still image. However, even when image quality of the preview image is low to some extent, no problem is raised. Since focus adjustment is performed on the basis of the preview image, given image quality is required. Particularly, focus adjustment is performed based on the result of detection of horizontal edges of a preview image, and hence a sufficient horizontal resolution is required. Therefore, when an image signal is acquired as a preview image, the CCD controller 14 reads the pixel value accumulated in the CCD 12 while vertically adding pixels to the pixel value (S18, S20). As a result of a pixel value being read while being added with pixels, the number of pixels of the finally-obtained image signal can be diminished, thereby enabling high-speed reading operation. Since a preview image requires a sufficient horizontal resolution, pixels are added to the image signal in only the vertical direction thereof.

The image signal, to which the pixels have been added in the vertical direction by the CCD controller 14, is output to the median filter circuit 18, and imperfect pixel correction processing is performed (S22). As mentioned previously, the median filter circuit 18 is a circuit for subjecting an image signal having a sufficient horizontal resolution to imperfect pixel correction processing. This circuit enables high-speed imperfection correction processing which is lower in accuracy than software processing.

The image signal having undergone hardware-like imperfect pixel correction processing performed by the median filter circuit 18 is further subjected to RGB color interpolation processing and resizing processing by the first image processing circuit 16. A YCC image is prepared from the resized image (S23), and the YCC image is temporarily stored in the internal memory 20 (S24). In accordance with an image processing program, the second image processing chip 22 expands the image signal temporarily stored in the internal memory into memory, and executes distortion correction processing of the image signal (S26). When the image signal is temporarily recorded in the internal memory 20, processing is completed. The images temporarily stored in the internal memory 20 are sequentially displayed on the LCD 28.

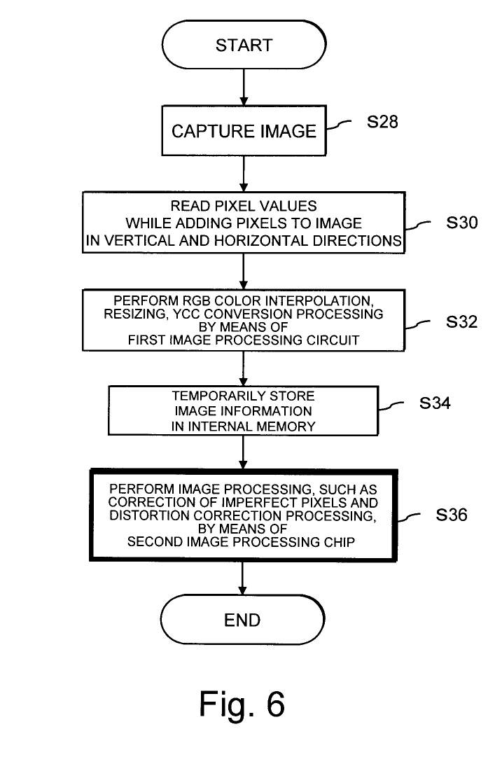

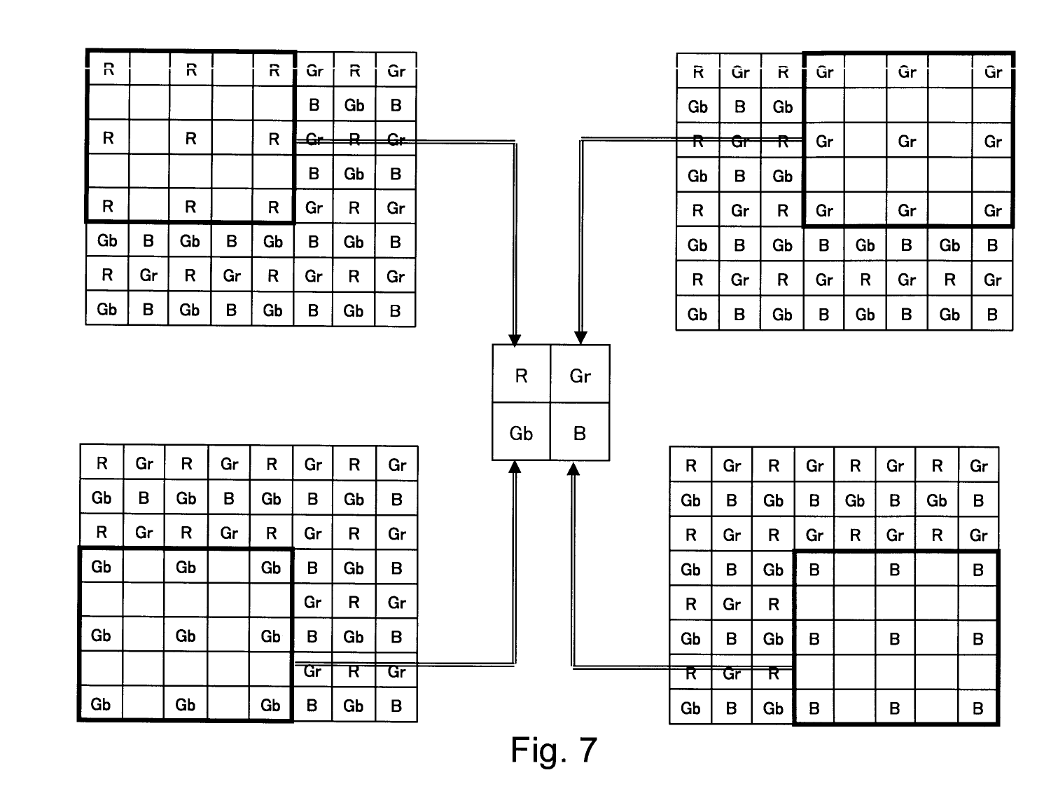

Flow of processing performed when an image signal is used as one frame of a moving image will now be described by reference to FIG. 6. When the image signal is used as one frame of a moving image, high-speed signal processing is required in order to maintain a frame rate (e.g., 1/30 sec.) of a moving image. Therefore, the CCD controller 14 reads the pixel value accumulated in the CCD 12 while adding pixels to the pixel value in both the horizontal and vertical directions (S28, S30). As shown in FIG. 7, pixel values of a single color arranged in both the vertical and horizontal directions are added together, and the result of addition is output as a new single pixel value. FIG. 7 shows an example case where a total of nine pixel values of a single color (three rows×three columns) are added together. However, another addition; e.g., addition of a total of 16 pixels of a single color (four rows×four columns), may also be adopted, so long as a pixel value can be read at a rate at which the frame rate can be maintained.

The image signal that has been read while being added with pixels is output to the first image processing circuit 16. The first image processing circuit 16 interpolates the signal input from the color filter into a color image for three channels RGB. Subsequently, the color image is resized to another size appropriate for a moving image. An RGB-expressed image signal is converted into a YCC expression (S32). So long as image processing is completed, an image signal is temporarily stored in the internal memory (S34).

In accordance with an image processing program, the second image processing chip 22 subjects the image signal temporarily stored in the internal memory 20 to comparatively-complicate image processing such as imperfection correction processing and distortion correction processing (S36). To this end, a work memory space is first ensured, and the image signal temporarily stored in the internal memory is read and expanded into the memory space. As long as the data can have been expanded into the memory space, the second image processing chip 22 performs imperfect pixel correction processing in accordance with an image processing program. As in the case of the still image, imperfect pixel correction processing is performed by reference to the previously-stored imperfect information. In the case of a moving image, pixel addition processing and RGB color interpolation processing are performed in advance, the image has previously been subjected to pixel addition processing and RGB color interpolation processing. Hence, recorded imperfection information cannot be directly utilized.

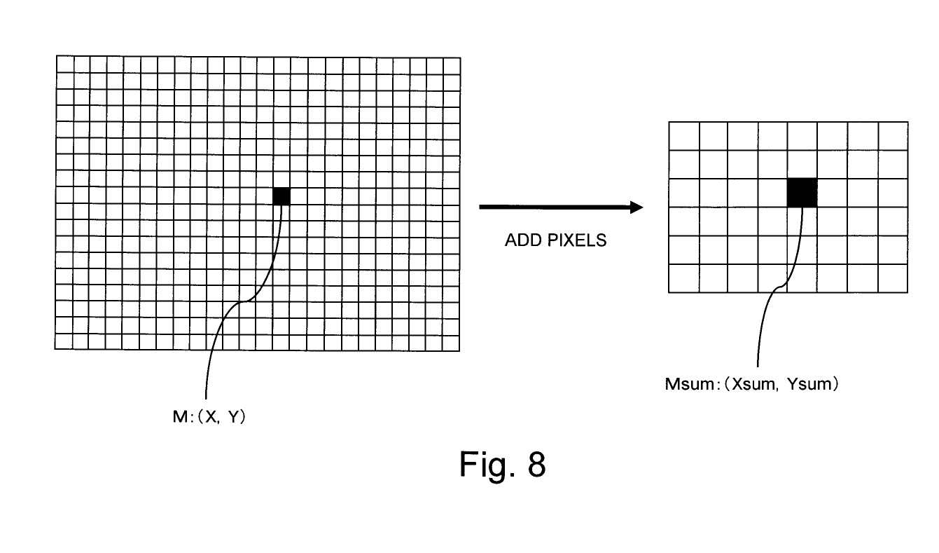

As shown in FIG. 7, in the case of a moving image, a pixel value is read while being added with a plurality of pixels, to thus create a new pixel value. Therefore, the position of the pre-addition imperfect pixel differs from the position of the imperfect pixel acquired after addition of pixels. For instance, in FIG. 8, after having been added with pixels, an imperfect pixel M located at coordinates (X, Y) comes to coordinates (Xsum, Ysum). Further, imperfection density Dsum of an imperfect pixel Msum acquired after addition of pixels is weakened as a result of addition of normal pixels. Hence, the imperfection density Dsum of the imperfect pixel Msum acquired after addition of pixels to the image signal is considered to have become smaller than the imperfection density D of the pre-addition initial imperfect pixel M.

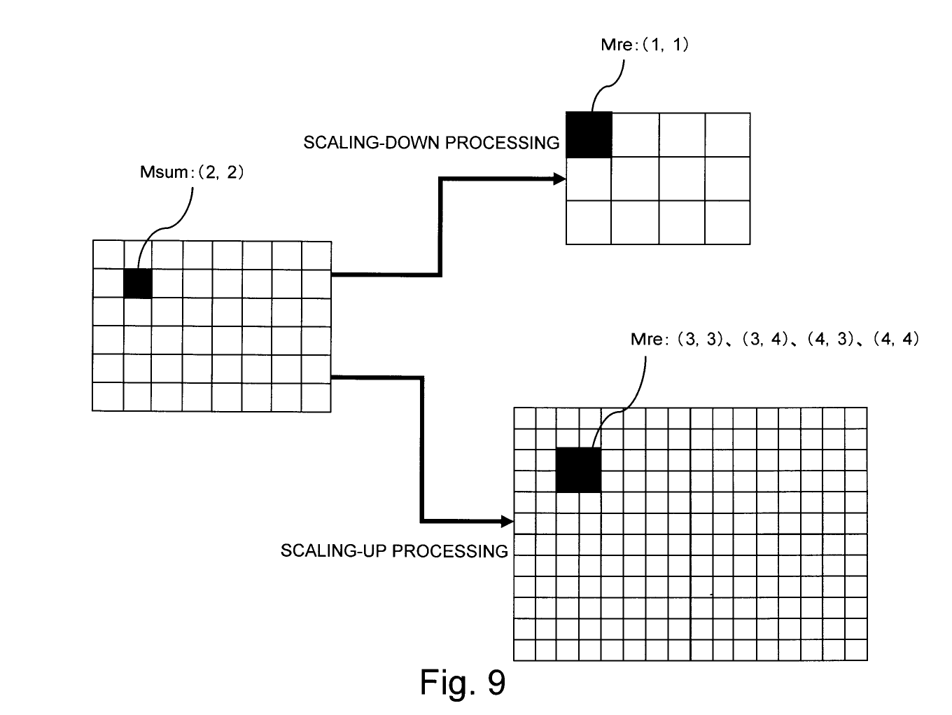

Coordinates and the number of imperfect pixels are also changed by RGB color interpolation and resizing. For instance, as shown in FIG. 9, when an image signal has been scaled down half, the imperfect pixel Msum located at coordinates (2, 2) is changed to coordinates (1, 1). Contrary, when an image signal is scaled up double by means of, e.g., nearest interpolation, coordinates of a scaled imperfect pixel Mre are predicted to extend up to (3, 3), (3, 4), (4, 3), (4, 4), or thereabouts.

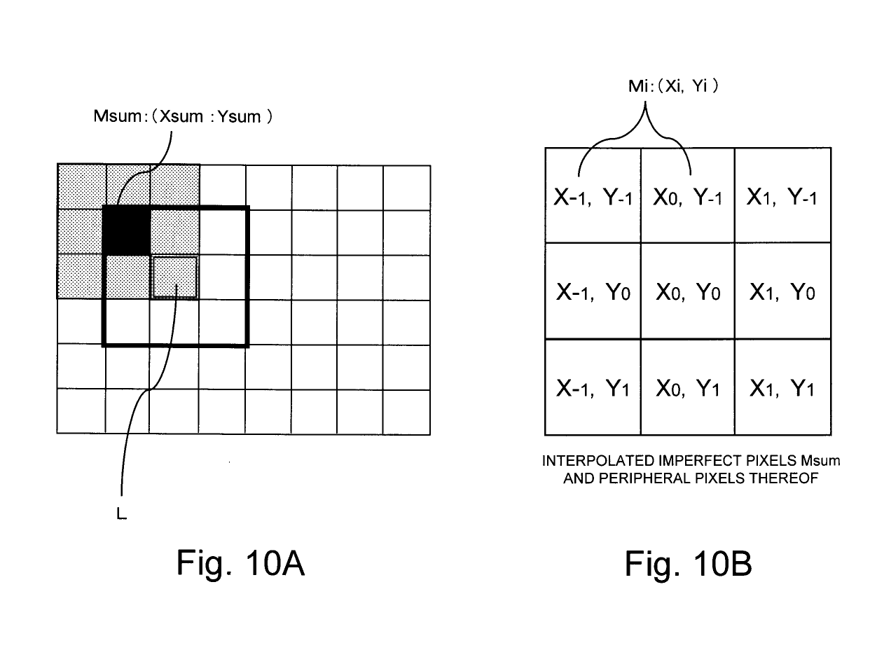

There may also be a case where the number of imperfect pixels are increased as a result of execution of RGB color interpolation processing. For instance, in FIG. 10, consideration is given to a case where a certain pixel L is subjected to RGB color interpolation processing on the basis of pixel values of eight pixels (enclosed by a thick line in FIG. 10) around the pixel L. At this time, when the imperfect pixel Msum is included in the eight pixels, the interpolated pixel L becomes an imperfect pixel Mi affected by the imperfect pixel Msum. When all of the pixels are subjected to RGB color interpolation processing, eight pixels around the imperfect pixel Msum finally become an imperfect pixel Mi affected by the imperfect pixel Msum. As in the case where the pixel value has been subjected to pixel addition, the imperfect pixel Mi having undergone RGB color interpolation processing and resizing is also affected by its surrounding normal pixels, and hence imperfection intensity Di is considered to have decreased.

As above, in the case of a moving image which is subjected to imperfect pixel correction processing having undergone pixel addition, RGB color interpolation, resizing, and the like, coordinates of imperfect pixels, the number thereof, and imperfect intensity of the same are changed. Meanwhile, the imperfection information stored in the internal memory 20 includes initial coordinates (X, Y) and initial imperfection intensity D of the imperfect pixel M acquired before addition of pixels. Therefore, this imperfection information cannot be utilized directly to imperfect pixel correction processing of the image signal having undergone pixel addition, RGB color interpolation, resizing, and the like. Accordingly, in the present embodiment, when an image signal for a moving image is subjected to imperfect pixel correction processing, coordinates of an imperfect pixel and imperfection intensity thereof in the image signal having undergone pixel addition, RGB color interpolation, and resizing, and the like, are first calculated from the imperfection information, and the like. The imperfect pixel is subjected to correction processing in accordance with the thus-calculated coordinates and the like.

There is specifically described flow of calculation of coordinates of the imperfect pixel Mi having undergone pixel addition, RGB color interpolation, resizing, and the like. As shown in FIG. 7, in the case of addition of nine pixels of a single color (three rows×three columns), coordinates (Xum, Ysum) of the imperfect pixel Msum having undergone pixel addition can be determined by means of substituting into Equation (1) coordinates (X, Y) of the imperfect pixel M that has not yet undergone pixel addition and are recorded in the imperfection information. In Equation (1), the term “floor” designates dropping of a fractional portion of the number.

Xsum=2·floor(X/6) {X is an even number}

Xsum=2·floor[(X−2)/6]+1 {X is an odd number}

Ysum=2·floor(Y/6) {Y is an even number}

Ysum=2·floor[(Y−2)/6]+1 {Y is an odd number} Eq. (1)

Next, the coordinates (Xi, Yi) of the imperfect pixel Mi having undergone RGB color interpolation and resizing can be determined by means of substituting coordinates (Xsum, Ysum) of the imperfect pixel Msum having undergone pixel addition into Equation (2).

Xi=(Xsum+1)*Ratio

Yi=(Ysum+1)*Ratio Eq. (2)

In Equation (2), the term “Ratio” denotes a resizing ratio (an output width/an input width). Further, symbol “i” denotes an integral value, wherein a range where the value can be acquired is changed by interpolation or the intensity of an imperfection. For instance, in connection with the interpolation method shown in FIG. 10, when the imperfection intensity Dsum of the imperfect pixel Msum having not yet subjected to RGB color interpolation processing is sufficiently large, “i” is defined as −1≦i≦1. Consequently, in this case, the imperfect pixel Mi having undergone RGB color interpolation processing corresponds to nine pixels as shown in FIG. 10. Meanwhile, in a case where the imperfection intensity Dsum of the imperfect pixel Msum having not yet subjected to RGB color interpolation processing is low, even when the imperfect pixel is subjected to RGB color interpolation processing, the influence of the imperfect pixel Msum on its surrounding eight pixels is considerably low. No problem is raised even when the surrounding eight pixels are handled as normal pixels. In such a case, the range of “i” may be defined as i=0.

As long as the coordinates of the imperfect pixel Mi can have been calculated, the second image processing chip 22 actually starts imperfect pixel correction processing. Subjecting an imperfect pixel having given initial imperfection intensity D or more to imperfect pixel correction processing is desirable. Specifically, the imperfection intensity Di of the imperfect pixel Mi achieved in the stage of imperfect pixel correction processing is predicted to have become sufficiently smaller than the initial imperfection intensity D achieved before addition of pixels. Subjecting the imperfect pixel having such low imperfection intensity D to imperfection correction processing results in an increase in processing time. Therefore, in the present embodiment, imperfection correction processing for imperfect pixels having given initial imperfection intensities D or less is omitted, thereby shortening the overall processing time. As a matter of course, the imperfection intensity Di achieved after RGB color interpolation processing and resizing operation may be calculated from the initial imperfection intensity D, and a determination may also be made, on the basis of the imperfection intensity Di, as to whether or not imperfect pixel correction processing is to be performed.

As long as imperfection correction processing has been completed, other image processing operations; e.g., distortion correction processing, handshake correction processing, and the like, are next performed. At this time, the image signal has already been expanded to the memory space, processing for re-ensuring a memory space or re-reading an image signal becomes obviated.

After all of the image processing operations have been completed, the image signal is converted into the MPEG format, and the thus-converted signal is stored in internal memory or external memory, whereupon processing is completed.

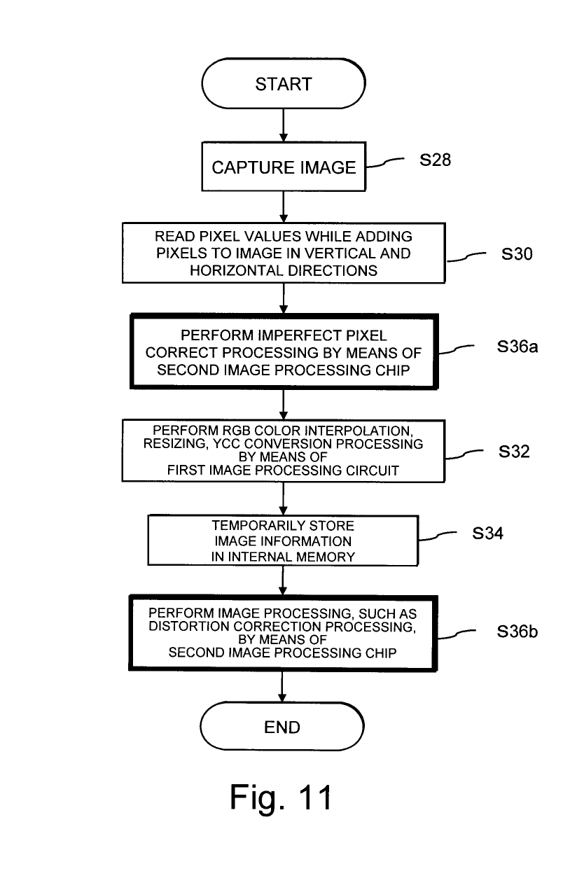

As is evident from the above descriptions, in the present embodiment, imperfect pixel correction processing is performed in the manner of software after pixel addition, RGB color interpolation processing, and resizing. The reason why imperfect pixel correction processing is performed in that sequence is because the entire processing time is shortened. Specifically, in order to perform imperfect pixel correction processing before addition of pixels, there is a necessity for reading a pixel value without addition of pixels, which in turn results in an increase in processing time. Further, in order to perform imperfect pixel correction processing before RGB color interpolation processing and resizing, an image signal must be expanded in memory before RGB color interpolation processing or the like, which also entails an increase in processing time. Flow of processing performed in this case is shown in FIG. 11. In the case of an image signal for a moving image having been horizontally and vertically added with pixels, pixel imperfection correction processing cannot be performed in the manner of hardware, and therefore there is no alternative way but to perform pixel imperfection correction processing in the manner of software. Consequently, when pixel imperfection correction processing (S36a) is performed before RGB color interpolation processing and resizing (S32), processing for expanding an image signal in memory is required before RGB color interpolation processing and resizing. Since image processing (S36b) based on software, such as distortion correction processing, is required after RGB color interpolation processing and resizing, the image signal must again be expanded in memory. Specifically, when pixel imperfection correction processing (S36a) is performed before RGB color interpolation processing and resizing (S32), the number of memory expansion processing operations is increased. Memory expansion processing for expanding an image signal formed from a plurality of pixels into memory requires a considerable amount of time. An increase in such memory expansion processing results in an increase in overall processing time. In short, when pixel imperfection processing is performed before RGB color interpolation processing and resizing, excessive memory expansion processing arises, and a total processing time is increased. Therefore, in the case of an image for a moving image which gives higher priority to a processing time rather than to image quality, hardware-like processing (pixel addition, RGB color interpolation processing, resizing, and the like) is intensively performed as shown in FIG. 6, and subsequently software-like processing is intensively performed. Thereby, the number of memory expansion operations can be minimized, and the overall processing time can be shortened.

As is obvious from the above descriptions, in the present embodiment, for the case of a moving image for which minimization of a processing time is desired, after hardware-like processing (pixel addition, RGB color interpolation processing, resizing, and the like) has been performed, software-like processing, including pixel imperfection correction processing, is intensively performed. Consequently, the number of memory expansion processing operations can be minimized, and quick processing can be performed. In accordance with imperfection intensity, a determination is made as to whether or not pixel imperfection correction processing is performed, and hence further shortening of a processing time can be achieved. Moreover, comparatively-simple processing is performed by the first image processing circuit that is a hardware circuit capable of performing high-speed processing. Therefore, when compared with the case of a still image for which all of processing operations are performed in the manner of software, the processing time can be shorted.

Moreover, in the present embodiment, processing timing of imperfect pixel correction processing is changed as required in accordance with an application of an image signal. Consequently, in the case of any one of a still image, a moving image, and a preview image, an appropriate result of signal processing can be obtained.

### Parts List

10 digital camera
11 lens unit
12 CCD
14 CCD controller
16 image processing circuit
18 median filter circuit
20 internal memory
22 second image processing chip
24 external memory
25 lens drive circuit
26 system controller
28 LCD
29 operation switch
30 pixel information
32 coordinates
34 strength
1,1 coordinates
2,2 coordinates
D imperfection density
Di imperfection density
L pixel
M imperfect pixel
Mi imperfect pixel
Mre imperfect pixel
Xi coordinates
Yi coordinates
X,Y coordinates
Dsum imperfection density
Msum imperfect pixel
Xsum,Ysum coordinates
S10 photography operation
S12 photography operation
S14 internal memory
S16 image processing software
S18 capture image
S20 adding pixel values
S22 pixel correction performed
S23 resized image
S24 internal memory
S26 distortion correction
S28 capture image
S30 adding pixel values
S32 resized image
S34 internal memory
S36 pixel correction performed
S36a correction processing
S36b distortion correction

1. A digital camera capable of handling at least a moving image and a still image, comprising:
an image-capturing element for capturing an image of a subject;
a pixel value reading unit for reading a pixel value of a unit pixel which is a unit of photoelectric conversion of the image-capturing element and outputting the pixel value as an image signal;
a first image processing unit for subjecting the image signal to image processing of one or more types by means of a hardware circuit; and
a second image processing unit for subjecting the image signal to image processing of one or more types by means of software processing, wherein,
at least when the image signal used as one frame of a moving image is subjected to processing, image processing to be performed by the second image processing unit is carried out after completion of all image processing operations performed by the first image processing unit.

2. The digital camera according to claim 1, wherein, at least when the image signal used as one frame of a moving image is subjected to processing,
the pixel value reading unit reads a pixel value while horizontally, vertically adding up pixels;
the first image processing unit subjects the image signal output from the pixel value reading unit to image processing including at least one of RGB color interpolation processing, resizing processing, and YCC image preparation processing; and
the second image processing unit subjects the image signal output from the first image processing unit to image processing including at least processing for correcting an imperfect pixel attributable to imperfections in the unit pixel.

3. The digital camera according to claim 2, further comprising:
a storage unit for storing imperfection information including positional information achieved before the imperfect pixel, which is an imperfect unit pixel, is subjected to pixel addition processing; and,
at least when an image signal used as one frame of a moving image is subjected to processing, the second image processing unit calculates, on the basis of the imperfection information, the position of the imperfect pixel that has undergone pixel addition and image processing performed by the first image processing unit, thereby performing imperfect pixel correction processing.

4. The digital camera according to claim 3, wherein the imperfection information further includes imperfection intensity information about the imperfect pixel that has not yet undergone pixel addition processing; and,
at least when an image signal used as one frame of a moving image is subjected to processing, the second image processing unit identifies an imperfect pixel whose imperfection intensity is less than a predetermined threshold value, on the basis of imperfection information, and omits imperfect pixel correction processing for an imperfect pixel whose imperfection intensity is less than the predetermined threshold value.

5. The digital camera according to claim 1, wherein,
when an image signal used as a still image is subjected to processing,
the pixel value reading unit outputs an image signal to the second image processing unit after having read a pixel value without addition of a pixel value; and
the second image processing unit subjects the image signal output from the pixel value reading unit to image processing including imperfect pixel correction processing.

6. The digital camera according to claim 5, wherein, when an image signal used as a still image is subjected to processing,
the second image processing unit first performs imperfect pixel correction processing and then performs other image processing operations.

7. The digital camera according to claim 1, further comprising
a compensation unit for subjecting the image signal, which has undergone vertical addition of pixels, to imperfect pixel correction processing by means of a hardware circuit; and,
when an image signal used as a preview image is subjected to processing,
the pixel value reading unit reads a pixel value while adding pixel values to the pixel value in only a vertical direction, and outputs an image signal to a correction unit;
the correction unit subjects the image signal output from the pixel value reading unit to imperfect pixel correction processing;
the first image processing unit subjects the image signal output from the correction unit to image processing including at least one of RGB color interpolation processing, resizing processing, and YCC image preparation processing; and
the second image processing unit subjects an image signal output from the first image processing unit to image processing other than imperfect pixel correction processing.
